(19) United States
(12) Patent Application Publication
(10) Pub. No.: US 2011/0082750 A1
(43) Pub. Date: Apr. 7, 2011

(54) Multi-Channel Digital Targeted Video Advertising System and Method

(76) Inventors: Michael Robert Beatty, La Mesa, CA (US); Robin Ross Cooper, La Mesa, CA (US)

(21) Appl. No.: 12/896,755

(22) Filed: Oct. 1, 2010

Related U.S. Application Data
(60) Provisional application No. 61/247,891, filed on Oct. 1, 2009.

(51) Int. Cl. G06Q 30/00

(52) U.S. Cl. 705/14.66

(57) ABSTRACT

A method and system for providing highly targeted advertising to remotely located viewers. The viewers are matched to an identifiable receiver on the system and, based on user preferences for products and services developed and stored on each user, targeted advertising for products and services each said user is likely to want, is substituted for the broadcaster advertising and communicated to the individual receivers matched with the user.

This application claims priority to U.S. Patent Application No. 61/247,891 filed on Oct. 1, 2009.

### BACKGROUND OF THE INVENTION

1. Field of the Invention The invention herein disclosed relates to the provision of advertising during television and video broadcasts by consumers. More particularly, it relates to a method and system for the provision of advertising to consumers which is specifically targeted to individual viewers based on assembled consumer profiles related to the respective viewer.

2. Prior Art

Broadcast media, such as off-air and satellite television as well as cable and internet broadcasts, conventionally carry advertisements for products and services. These advertisements are conventionally communicated to the viewers during brief interruptions of the movie, sporting event, or other media being watched by a viewer. Such advertisements are the broadcaster's mode of generating revenue from the media being transmitted to the viewers, and conventionally, are a product or service provider's means to inform the viewing audience of the availability of products and services.

However, such advertisements are generally communicated to masses of viewers based on predicted audience demographics as a whole as relating to the type of show, movie, or other media being broadcast. In other words, based on past advertising and buyer research as it relates to viewers of certain types programs, the members of the viewing audience may be predicted. Such predictions or estimations conventionally try to define the viewers' ages, income levels, education, and other factors, based on past research for such programs. In turn, future broadcasts of similar programs are predicted to have a certain type of audience watching the showing of the program.

Programs and events which appeal generally to young people and which have, in past research, been shown to yield a specific audience, will likely attract advertisers with products such an audience predictably finds attractive. Shows and programs which attract the entire family irrespective of ages are likely to have advertisements for products which relate to the family. Also, programming which has, according to past research, attracted an older audience will generally carry advertisement for products and services an older audience might want.

For instance, a program likely to attract senior citizens based on previous broadcasts and viewer research and interviews, will likely carry advertisement for products which older viewers might want such as insurance, medical devices, drugs, and those products and services a greying audience may find of interest. Conversely, a rock concert or program featuring young hip characters, will likely appeal to younger viewers. Advertisers for products of interest to these viewers will book advertising during such a showing.

This system of advertising based on predicted mass audiences however, is outmoded in a modern digital world. For instance, based on issued discount cards and accounts, most supermarkets, in addition to customer's address, phone, and personal information, have a plethora of information about individual customers buying habits, ages, and tastes, based on buying habits for products. Similar databases exist for individual customers and households which hold information on products which have already been purchased such as cars or appliances. Warranty cards for many products are used more to ascertain the demographics and locations of buyers than to actually register the buyers. These examples are but a small sampling of the mass of highly specific individualized information on individuals which has been amassed in most modern countries.

Additionally, most households with cable or satellite connections for broadcast media, unknown to the subscriber, are known individually to the cable or satellite providers by name and address and their electronically identified location on the receiving end of a broadcast. Cable companies can relate the location of each individual receiver to an address and household full of known individuals. The same is true of satellite broadcasts where each receiver is known to the satellite broadcaster by location and in relation to the individuals at that location. In the case of cable companies, by ascertaining the individual receivers online, real time information is discernable for each household on the system. In the case of satellite and other receivers, most communicate reports to the vendor as to what has been watched by which receiver and when it was watched.

Employing this mass of data, and these known locations, with known individuals, stored in relational databases, the watching habits of individual households and users may be conventionally cross-referenced with other databases of manufacturers, retailers, and service providers. Using the advertiser information, warranty information, retailer information, and the plethora of other sources available as to individual purchasing habits, individual files can be developed which have information concerning what products and services individuals in specific homes and locations own, or have bought in the past. Conversely, what products and services which have not been purchased or sought by these individuals can be ascertained.

However, broadcast media continues to provide commercial messages to advertisers based on predicted audiences with predicted demographic qualities in what is at best an inaccurate manner for the advertisers to reach their desired audience.

As such, there exists an unmet need for a device and method which will employ the readily available highly individualized data about individuals occupying specific addresses receiving cable and satellite broadcasts, so as to customize the advertisements received by each location, to the known occupants. Such a system should provide advertisers with a means to insert highly targeted advertisements, for specific products and services, directly into the stream of the received broadcasts of individual households. These advertisements, using the system herein, may be individually targeted to each household or location, based on cross referenced consumer databases, and based on the known occupants of each location, and the products they already own, the products they are seeking, and products they are likely to want. Thus advertisements, for something already owned by one viewer, might be sent instead to viewers likely to buy such items. The user already owning them instead might be send information about attachments to the owned device, repairs, or other products likely to be desired by known owners of a particular product.

### SUMMARY OF THE INVENTION

The disclosed device and method herein provide a novel system to remedy the conventional inaccuracy of broadcast advertising to homes with cable and satellite cable, satellite and IPTV reception systems. Further, viewers with Digital Video Recorders which communicate with the provider, may also be sent individualized advertising even if they are frequently recording off-air programs.

Conventionally, each such video receiver in each home or business is identifiable for its individual location, by cable, satellite and IPTV providers, using electronic serial numbers, and/or IP addresses, and other electronic identifiers. Each such receiver is also generally controllable by the broadcaster or cable, satellite and IPTV provider based on these individual electronic identifiers. Further, the ability of the broadcaster to send electronic signals downline to elicit specific actions by the cable, satellite and IPTV receivers in a location is already available.

Using this known receiver location, and control thereof, and the known individuals at the location and in most occasions the individual receiver, the cable and satellite broadcasters, can cause the individual receivers to display specific advertisements during commercial breaks. The exact time of commercial breaks during each program is conventionally known in advance to the broadcasters and cable companies and using this information they may easily insert individualized advertisements during each such advertising time period.

The advertisements to be so inserted may be broadcast in a plurality of individual ads in real time for real time display at the known advertising time periods during a particular program. Or, they may be sent to recorders on the receivers prior to anticipated viewing times for each receiver, wherein they are recorded and stored on the digital video recorder of the subscribers and then activated to play at appropriate times.

The system and method herein, known as “DIVA” employs the known information about individual subscribers to cable, satellite and IPTV feeds, using the electronic identifiers of receivers and known information about users using the individual receivers, offers an advanced suite of technologies that provide consumer specific targeted advertising based on consumer profiles.

In use, individual viewer profiles are built from a number of different sources. Some such information is from opt-in information that the customer provides, such as indicating their preferences for advertising or household demographic data such as the number of people in the household, their genders, age brackets, income, cars, etc. Profile information is also gleaned from tracked or ascertained television viewing patterns both for content as well as advertising which has been gathered in the past. Public records are also a source of consumer profile information. Marriage, divorce, bankruptcy, judgments, and property records can all be used to enhance the information used to build an individual consumer profile, which is relatable to the individual receiver in the geographic location of the individual respective consumer, making it highly accurate.

For advertisers or agencies, the DIVA system provides a global advertising distribution system that can distribute targeted advertising to any linked in DIVA system in the world. DIVA allows the advertisement agency the ability to target their customer's advertisements to multiple markets and to act as advertising clearing houses for advertisers. Advertisements can be managed, marketed and sold between DIVA systems in multiple geographic markets between multiple advertisers.

Using the system, an advertising agency in New York and an advertising agency in California both would both have DIVA systems. The New York agency has advertiser relationships with car companies such as Honda and Ford and might employ its DIVA connections to Telcos in Belgium and Australia to sell to viewers in that venue. The California agency may also have advertiser relationships with the same companies and employ a DIVA connection to a Telco provider of broadcasting to viewers in Australia to sell the same products on an individualized basis based on viewer profiles. Thus, both agencies reach the individual customers identified by their viewer consumer profiles without interfering with the other.

When a DIVA enabled system connects to another DIVA system, it has access to the remote DIVA systems demographic data to allow it to determine how many potential advertisers fit the target consumer profile they're trying to reach. It also has access to the EPG and advertising avails for the target system to allow it to select the appropriate ad slots for the advertiser. Since each target DIVA system can host advertising from any number of remote DIVA systems, the target DIVA system maintains a database of blocking out all advertising avails that have been reserved. There can be multiple targeted ads for each ad slot as long as the target profile is different. For example, this allows the California advertising agency to sell ads in the Belgium Telco for the same ad slot as the New York advertising agency as long as they are targeting different viewers based on different consumer profiles. Since multiple ads can be targeted for the same ad slot, the DIVA client, using software adapted to the task, will switch to the one that most closely matches its consumer profile.

The DIVA Targeted Ad Server (DTAS) employs an edge server that sends the targeted ad to the switches on the edge network which DIVA clients can then employ when a targeted ad that matches the individual client profile is detected. The DTAS monitors all broadcast streams at the edge to determine individual ad slots that match the targeted ad slots. When ad slots are detected that match one or more targeted ads, the DTAS begins multi casting one or more targeted ad(s) which goes to the switch. Once the multicast arrives at the switch, the switch waits for a downstream client to request the multicast stream before sending the individualized ad to the client device. By multi casting at the edge to the edge switch, the least amount of bandwidth possible is utilized to allow the greatest number of targeted ads to be delivered to the identified and targeted consumer video receiving devices that are requesting the targeted ads.

In use, a management server employs a back-end server to handle DMS server related transactions which is connected to a database such as an SQL database and a graphic user interface. The DIVA Profile Generator also interfaced and is responsible for creating and updating consumer profiles and a billing system which gathers and generates billing reports.

The DMS is responsible for scheduling advertising in one or more target markets for either VOD or broadcast content. The advertisement video content is delivered to DIVA by either FTP or other electronic file delivery means. When an advertiser wants access to a market, it must be authorized to access it. For example, an advertising agency which has contacts with multiple advertisers will use their DIVA system to contact other DIVA systems throughout the world. Each DIVA system they connect to is then available to them when they have authorization.

DIVA utilizes assembled individual consumer profiles for targeting ads to respective consumers. For each target market, DIVA maintains a database of consumer profiles associated with each household. Household profiles as noted, are generated based on opt-in data, viewing habits and public records data and other conventional means of assembling consumer data. DIVA protects consumers by referencing individual households known by the electronic identifiers of each receiver on the network, by employing unique numbers relating to each user and never actual names or addresses.

The DMS management server can be used by advertisers directly, advertising agencies which act as brokers for advertisers wishing to place ads on various networks, or by the operators themselves wishing to control the advertising on their local network. Operators can elect to invite external DIVA systems to target ads on their systems, opening the door for global advertising distribution and revenue sharing.

The Data Transmission Service (DTS) such as a Microsoft released Data Transformation Services employed along with an SQL Server is a powerful, easy to use, graphical tool for importing, exporting and transforming data, responsible for recording transactions from both the DTAS (DIVA Targeted Ad Server) and from the DIVA clients which periodically send ad and program viewing information to the DTS. The ad viewing information received from the DIVA clients is used to determine the number of ads viewed and the duration of each view in each household. Based on the transmitted advertisements, this information is then fed into the billing system to generate billing and advertising effectiveness reports for the advertisers. The DTS is also responsible for storing interactive responses from the DIVA client. Certain ads can be labeled as interactive, allowing for telescoping or RFI (Request For Information) transactions.

The DTS communicated data is also used by the DIVA Profile Generator to analyze channel viewing patterns and update consumer profiles with this information, as well as provide RFI fulfillment requests to the operators or directly to the product manufacturers.

The Diva Profile Generator (DPG) connects to a back-end server, in order to handle DPG related transactions. A DIVA Client Interface Server handles requests from DIVA clients for retrieving client profiles. The DPG is responsible for creating and updating individual consumer profiles. Consumer profiles describe the consumer demographics for each market. The DPG makes that information available to external DMS systems as well as the local DMS. The local DMS provides the profile information to the DIVA client. The profile is what the DIVA client uses to determine which ads will be shown on the consumer device. External DMS systems use the DPG information to target which consumer profiles within a market will receive the ads they are targeting for that market.

As noted, individual viewer consumer profiles are built from a number of different sources. Customer may provide opt-in information, such as indicating their preferences for advertising or household demographic data such as the number of people in the household, their genders, age brackets, income, cars, etc. Such individualized profile information is also gleaned from television viewing patterns both for content as well as advertising. Public records are also an excellent source of consumer profile information since marriage, divorce, bankruptcy, judgments, and property records can all be used to enhance the information used to build an individual consumer profile related to one or more receivers at an identified location, making the profile more accurate.

The DIVA Targeted Ad Server (DTAS) is communicating with the system on the edge preferably in the same physical location as the switching equipment. Each DTAS monitors the broadcast traffic flowing into the switches and looks for targeted advertising slots which are conventionally injected at the broadcaster scheduled time slots by the RTAP at the head end. These individual targeted advertising slots are defined by the Diva Management Server (DMS) which stores the broadcaster or scheduled time slots during programming which is allotted for advertisements. The DTAS queries the DMS for upcoming ad slots for which it should prepare targeted ad streams. For example, the DTAS will query the DMS and ask for all targeted ads that will be available in the next 24 hours for each channel. The DMS will return the ad slots, times, and profiles the ad slots are targeting along with the actual ad that will be streamed. The DTAS then monitors the data stream coming into the switch for the ad slots using conventional Digital Program Insertion Cueing such as SCTE 35 SCTE-35 CUES to identify the availability of insertion slots. Once the avail is detected, DTAS begins streaming one or more targeted ads to the switch. The switch employs an IGMP snoop capable switch which listens to the datastream and waits for one or more multicast join requests from DIVA clients. Each client that requests the multicast is then sent the targeted advertising stream for the time slot, instead of the normal broadcast stream ad that would appear in that time slot.

An RTAP server runs at the head end and intercepts every broadcast channel sent from the broadcast streamer. The RTAP's purpose is to inject SCTE-35 ad cues into the broadcast channel stream as avails are detected.

The RTAP communicates with the local DMS to obtain the avail and profiles targeted for each avail in a broadcast channel. As avails are detected in the broadcast stream, the RTAP will determine which ad profiles are being targeted for the avail and inject SCTE-35 CUES into the stream which identify the individual profiles being targeted.

The modified streams are then streamed as they normally would over the various switches and routers throughout the network. Upon arrival at an edge site, the DTAS server watches all incoming traffic for the SCTE-35 cues that RTAP inserted. The DTAS server then uses this data to determine the ad streams to begin streaming over the edge network to the individual subscriber client receiving devices. The DIVA Client running in the client device also monitors for these SCTE-35 cues to determine when and which targeted ad stream to switch to.

In one preferred mode of the system, the RTAP uses the SCTE-35 null packet types to convey target profiles to the DTAS and DCL. The RTAP injects these packets into the linear stream, and also adjusts the MPEG PCR values to adjust for the increased bit rate the additional packets cause. The RTAP injects the null packets after injecting schedule packets. The schedule packets tell downstream listeners (DTAS and DCL) that an avail is upcoming and to prepare for it. The RTAP injects the schedule packets at 1 second intervals, 5 seconds before the avail is scheduled to start.

Once the avail is scheduled to begin, then an insert packet is injected which tells the downstream DTAS to begin streaming ads, and the downstream DCL to make the switch to the targeted ad stream. The RTAP also needs to inject this sequence of packets towards the end of each targeted avail. This ending sequence tells the downstream listeners if either another targeted avail is coming or if this is the last targeted avail. If another targeted avail is coming, then both DTAS and DCL will make the preparations to begin streaming the next set of ads (DTAS) or which ad stream to switch to next (DCL). If this is the final targeted avail, then the DTAS need do nothing, while the DCL will switch back to the original linear ad stream.

For VOD (Video On Demand) systems, the RPAS server, shown in FIG. 7, runs at the head end and intercepts every RTSP request sent to the head end VOD server from a client. The RPAS's purpose is to inject commercials into the VOD ad stream based on the connecting client or subscriber's individual targeted advertising profile. When a client requests a VOD asset, RPAS uses the DMS provided profile information and associates the user's targeted advertising profile. The RPAS then checks for a targeted ad playlist that matches the individual user's profile. If a match is found, then the playlist which is composed of a series of commercials, is sent to the client followed by the VOD asset the user originally requested.

The RPAS communicates with the local DMS to obtain the profile information both for the client and the targeted ad profiles the VOD asset is targeted. In order to report on ad views, the RPAS updates the DMS database as advertising is streamed to the client.

The DIVA Client Library shown in FIG. 8, runs on the consumer client receiver device and is responsible for gathering consumer viewing habits and determining which advertising stream will be joined during commercial breaks. The DCL is a library that is loaded in the client device along with the content viewing application. When the DCL is initialized, it contacts the DMS to obtain its profile information. The DPG component provides the profile to the DMS which returns it to the DCL. The DCL then uses that profile to determine which commercial stream to switch to when an avail is detected.

The DCL then records all channel change and viewing duration as well as the advertising contained within the linear stream. The viewing application passes each packet of data it receives to the DCL which inspects it for avails. As avails are detected, the DCL checks its profile against the profiles the avail is targeted at. If a match is made, the DCL switches to the ad stream indicated in the avail.

Periodically, the DCL will send channel and advertising viewing information to the DTS. The DTS then stores this information in the SQL database for both billing, analysis and profile generation functions.

With respect to the above description, it is to be understood that the invention is not limited in its application to the details of operation nor the arrangement of the components or steps in the method set forth above or in the following descriptions or in the illustrations in the drawings. The various methods of implementation and operation of the disclosed advertising targeting system herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of methods and systems for carrying out the several purposes of the present invention to stream targeted advertisement to viewers based on their individual profiles. Therefore, the objects and claims herein should be regarded as including such equivalent construction, steps, and methodology insofar as they do not depart from the spirit and scope of the present invention.

Further objectives of this invention will be brought out in the following part of the specification wherein detailed description is for the purpose of fully disclosing the invention without placing limitations thereon.

It is an object of this invention to provide advertisers highly targeted consumers for their advertisements for their goods and services.

It is another object of this invention to provide such a system which by design, also provides consumers with advertisements that better relate to their interests and buying patterns.

It is a further object of the invention to provide such a system that relieves consumers from watching advertisements that would rarely interest them and allows advertisers to avoid ads to consumers least interested in their products and services.

These together with other objects and advantages which become subsequently apparent reside in the details of the construction and operation of pleural effusion drainage system and method herein as more fully hereinafter described and claimed, reference being had to the accompanying drawings forming a part thereof, wherein like numerals refer to like parts throughout.

### BRIEF DESCRIPTION OF DRAWING FIGURE

FIG. 1 Depicts the system herein disclosed in a graphic flow depiction.

FIG. 2 depicts the DMS management server having a back-end server to handle DMS related transactions.

FIG. 3 depicts the DIVA Targeted Ad Server (DTAS)

FIG. 4 depicts the RTAP server which is employed at the head end.

FIG. 5 shows the DTS consists of a back-end server to handle DTS related transactions.

FIG. 6 depicts the DPG which connects to a back-end server, in order to handle DPG related transactions.

FIG. 7 shows a representation of the RPAS server, employed at the head end and intercepts every RTSP request.

FIG. 8 depicts the DIVA Client Library operating on the consumer client receiver device and employed for detecting targeted ads, determining which targeted ad best suits the client profile, and performing the switching functions required to tune to the targeted ad multicast, and then tune back to the main linear program after the targeted ad is completed. The DCL is also used for gathering consumer viewing habits and reporting those viewing habits back to the DIVA server.

### DETAILED DESCRIPTION OF THE PREFERRED

### Embodiments of the Invention

The disclosed device and method herein provide a novel system to remedy the conventional inaccuracy of broadcast advertising to homes with cable and satellite cable, satellite and IPTV reception systems. Further, viewers with Digital Video Recorders which communicate with the provider, may also be sent individualized advertising even if they are frequently recording off-air programs.

Conventionally, each such video receiver in each home or business is identifiable for its individual location, by cable, satellite and IPTV providers, using electronic serial numbers, and/or IP addresses, and other electronic identifiers. Each such receiver is also generally controllable by the broadcaster or cable, satellite and IPTV provider based on these individual electronic identifiers. Further, the ability of the broadcaster to send electronic signals downline to elicit specific actions by the cable, satellite and IPTV receivers in a location is already available.

Using this known receiver location, and control thereof, and the known individuals at the location, the cable and satellite broadcasters, can cause the individual receivers to display specific advertisements during commercial breaks. These advertisements may be broadcast in a plurality of individual ads in real time for real time display during a particular program. Or, they may be sent to recorders on the receivers prior to anticipated viewing times for each receiver, wherein they are recorded and stored on the digital video recorder of the subscribers and then activated to play at appropriate times.

The system and method herein, known as “DIVA” employing the known information about individual subscribers to cable, satellite and IPTV feeds, using the electronic identifiers of receivers and known information about users using the individual receivers, offers an advanced suite of technologies that provide consumer specific targeted advertising based on consumer profiles.

In use, consumer profiles are built from a number of different sources. Some such information is from opt-in information that the customer provides, such as indicating their preferences for advertising or household demographic data such as the number of people in the household, their genders, age brackets, income, cars, etc. Profile information is also gleaned from tracked or ascertained television viewing patterns both for content as well as advertising which has been gathered in the past. Public records are also a source of consumer profile information. Marriage, Divorce, bankruptcy, judgments, property records can all be used to enhance the information used to build an individual consumer profile, which is relatable to the individual receiver in the geographic location of the individual respective consumer, making it highly accurate.

For advertisers or agencies, the DIVA system provides a global advertising distribution system that can distribute targeted advertising to any linked in DIVA system in the world. DIVA allows the advertisement agency the ability to target their customer's advertisements to multiple markets and to act as advertising clearing houses for advertisers. Advertisements can be managed, marketed and sold between DIVA systems in multiple geographic markets between multiple advertisers.

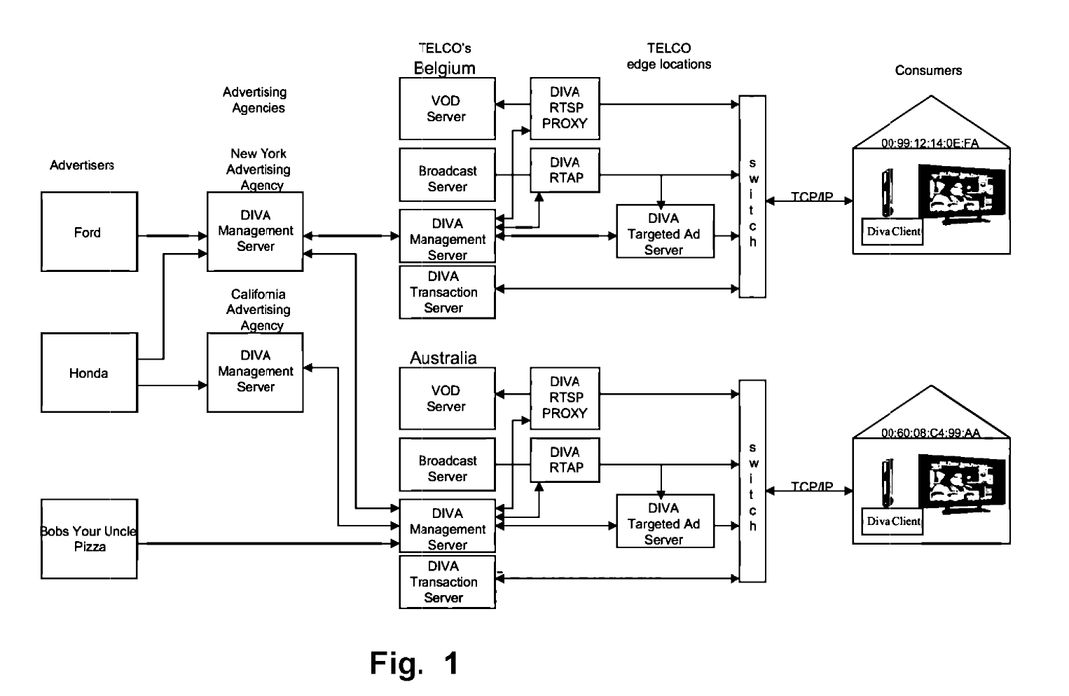

An example of this is depicted in FIG. 1 of the attached drawings. An advertising agency in New York and an advertising agency in California both have DIVA systems. They both sell advertising slots to advertisers using DIVA. They are part of the DIVA worldwide advertising system so they have access to markets worldwide. The New York agency has advertiser relationships with Honda and Ford and DIVA connections to Telco's in Belgium and Australia. The California agency has advertiser relationships with Honda and a DIVA connection to a Telco in Australia. The Australian Telco also has a direct advertiser relationship with a local advertiser called Bob's Your Uncle Pizza. This shows the flexibility of the DIVA system to allow advertisers, ad agencies and local Telco's to sell advertising in a worldwide advertising distribution system.

When a DIVA enabled system connects to another DIVA system, it has access to the remote DIVA systems demographic data to allow it to determine how many potential advertisers fit the target consumer profile they're trying to reach. It also has access to the EPG and advertising avails for the target system to allow it to select the appropriate ad slots for the advertiser. Since each target DIVA system can host advertising from any number of remote DIVA systems, the target DIVA system maintains a database of all advertising avails that have been reserved. There can be multiple targeted ads for each ad slot as long as the target profile is different. For example, this allows the California advertising agency to sell ads in the Belgium Telco for the same ad slot as the New York advertising agency as long as they are targeting different consumer profiles. Since multiple ads can be targeted for the same ad slot, the DIVA client will switch to the one that most closely matches its consumer profile.

The DIVA Targeted Ad Server (DTAS) is the edge server that sends the targeted ad to the switches on the edge network which DIVA Clients can then switch to when a targeted ad that matches the client profile is detected. The DTAS monitors all broadcast streams at the edge, to determine individual ad slots that match the targeted ad slots. When ad slots are detected that match one or more targeted ads, the DTAS begins multi casting one or more targeted ad(s) which goes to the switch. Once the multicast arrives at the switch, the switch waits for a downstream client to request the multicast stream before sending it to the client device. By multi casting at the edge to the edge switch, the least amount of bandwidth possible is utilized to allow the greatest number of targeted ads to be delivered to the identified and targeted consumer video receiving devices that are requesting the targeted ads.

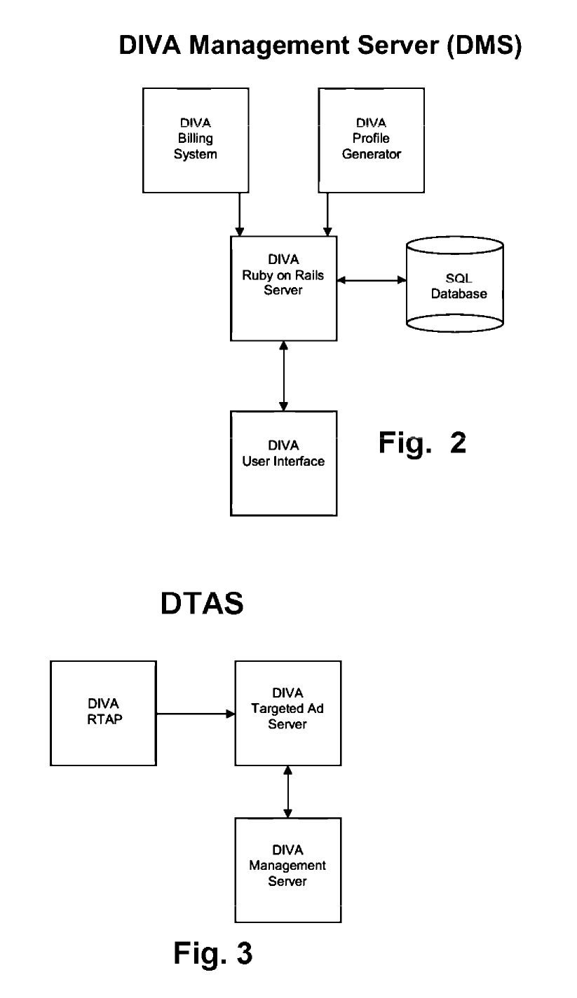

As depicted in FIG. 2, DMS, a management server consists of a back-end server to handle DMS related transactions connected to an SQL database, a GUI, the DIVA Profile Generator which is responsible for creating and updating consumer profiles and a billing system which gathers and generates billing reports.

The DMS is responsible for scheduling advertising in one or more target markets for either VOD or broadcast content. The advertisement video content is delivered to DIVA by either FTP or other delivery means. When an advertiser wants access to a market, it must be authorized to access it. For example, an advertising agency which has contacts with multiple advertisers will use their DIVA system to contact other DIVA systems throughout the world. Each DIVA system they connect to is then available to them.

DIVA utilizes assembled individual consumer profiles for targeting ads to respective consumers. For each target market, DIVA maintains a database of consumer profiles associated with each household. Household profiles as noted, are generated based on opt-in data, viewing habits and public records data and other conventional means of assembling consumer data. DIVA protects consumers by referencing individual households known by the electronic identifiers of each receiver on the network, by employing unique numbers relating to each user and never actual names or addresses.

The DMS management server can be used by advertisers directly, advertising agencies which act as brokers for advertisers wishing to place ads on various networks, or by the operators themselves wishing to control the advertising on their local network. Operators can elect to invite external DIVA systems to target ads on their systems, opening the door for global advertising distribution and revenue sharing.

In FIG. 3, the DIVA Targeted Ad Server (DTAS) as shown, resides on the edge preferably in the same physical location as the switching equipment. Each DTAS monitors the broadcast traffic flowing into the switches and looks for targeted advertising slots which are conventionally injected by the RTAP at the head end. These individual targeted advertising slots are defined by the DMS which the DTAS queries for ad slots for which it should prepare targeted ad streams. For example, the DTAS will query the DMS and ask for all targeted ads that will be available in the next 24 hours for each channel. The DMS will return the ad slots and profiles the ad slots are targeting along with the actual ad that will be streamed. The DTAS then monitors the stream coming into the switch for the ad slot using SCTE-35 CUES to identify the avail. Once the avail is detected, DTAS begins streaming one or more targeted ads to the switch. The switch is an IGMP snoop capable switch that waits for one or more multicast join requests from DIVA clients. Each client that requests the multicast is then sent the targeted advertising stream instead of the normal broadcast stream.

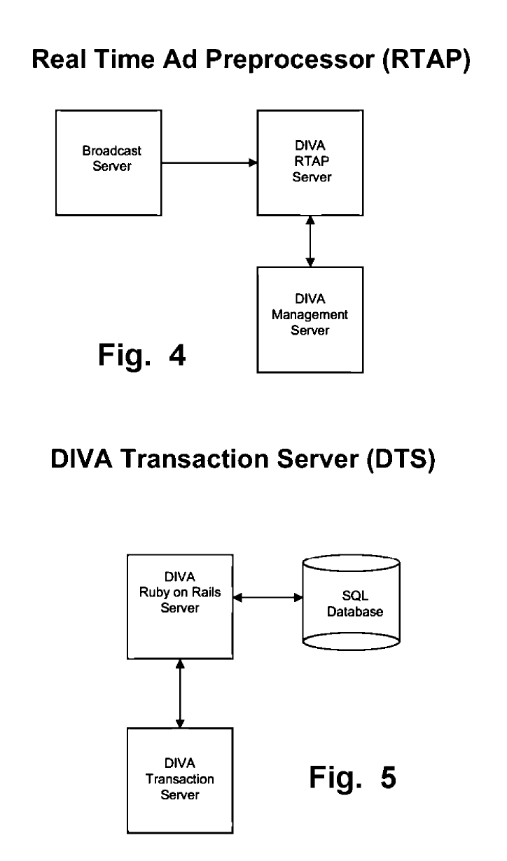

Shown in FIG. 4, the RTAP server runs at the head end and intercepts every broadcast channel sent from the broadcast streamer. The RTAP's purpose is to inject SCTE-35 ad cues into the broadcast channel stream as avails are detected.

The RTAP communicates with the local DMS to obtain the avail and profiles targeted for each avail in a broadcast channel. As avails are detected in the broadcast stream, the RTAP will determine which ad profiles are being targeted for the avail and inject SCTE-35 CUES into the stream which identify the individual profiles being targeted.

The modified streams are then streamed as they normally would over the various switches and routers throughout the network. Upon arrival at an edge site, the DTAS server watches all incoming traffic for the SCTE-35 cues that RTAP inserted. The DTAS server then uses this data to determine the ad streams to begin streaming over the edge network to the individual subscriber client receiving devices. The DIVA Client running in the client device also monitors for these SCTE-35 cues to determine when and which targeted ad stream to switch to.

In one preferred mode of the system, the RTAP uses the SCTE-35 null packet types to convey target profiles to the DTAS and DCL. The RTAP injects these packets into the linear stream, and also adjusts the MPEG PCR values to adjust for the increased bit rate the additional packets cause. The RTAP injects the null packets after injecting schedule packets. The schedule packets tell downstream listeners (DTAS and DCL) that an avail is upcoming and to prepare for it. The RTAP injects the schedule packets at 1 second intervals, 5 seconds before the avail is scheduled to start.

Depicted graphically in FIG. 5, the DTS consists of a back-end server to handle DTS related transactions. The DTS provides a transaction messaging interface which receives transaction data from other DIVA components.

The DTS is responsible for recording transactions from both the DTAS (DIVA Targeted Ad Server) and from the DIVA clients which periodically send ad and program viewing information to the DTS. The ad viewing information received from the DIVA Clients is used to determine the number of ads viewed and the duration of each view in each household. This information is then fed into the billing system to generate billing and advertising effectiveness reports for the advertisers. The DTS is also responsible for storing interactive responses from the DIVA client. Certain ads can be labeled as interactive, allowing for telescoping or RFI (Request For Information) transactions.

The DTS data is also used by the DIVA Profile Generator to analyze channel viewing patterns and update consumer profiles with this information, as well as provide RFI fulfillment requests to the operators or directly to the product manufacturers.

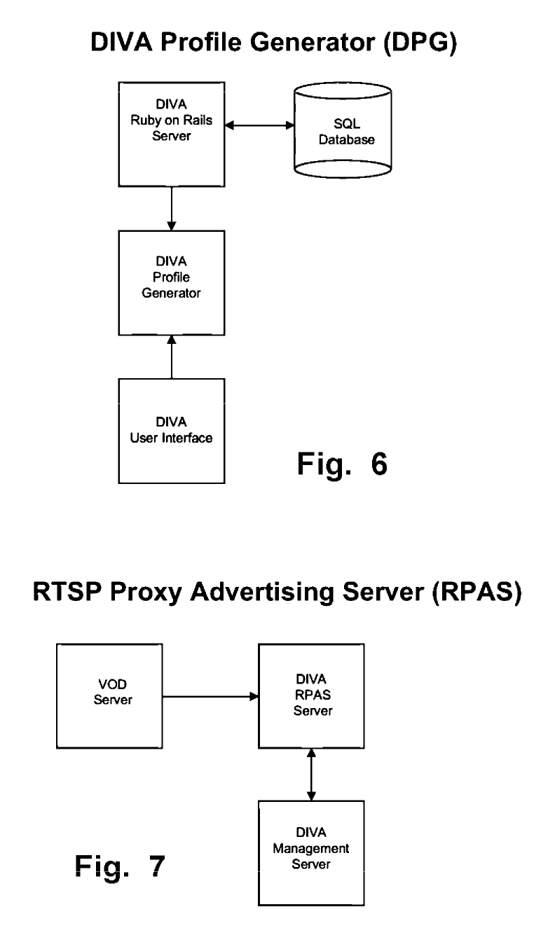

The DPG shown depicted as FIG. 6, connects to a back-end server, in order to handle DPG related transactions. A DIVA Client Interface Server handles requests from DIVA Clients for retrieving client profiles.

The DPG is responsible for creating and updating individual consumer profiles. Consumer profiles describe the consumer demographics for each market. The DPG makes that information available to external DMS systems as well as the local DMS. The local DMS provides the profile information to the DIVA client. The profile is what the DIVA client uses to determine which ads will be shown on the consumer device. External DMS systems use the DPG information to target which consumer profiles within a market will receive the ads they are targeting for that market.

As noted, individual consumer profiles are built from a number of different sources. Opt-in information that the customer provides, such as indicating their preferences for advertising or household demographic data such as the number of people in the household, their genders, age brackets, income, cars, etc. Such individualized profile information is also gleaned from television viewing patterns both for content as well as advertising. Public records are also and excellent source of consumer profile information since marriage, divorce, bankruptcy, judgments, and property records can all be used to enhance the information used to build an individual consumer profile related to one or more receivers at an identified location, making the profile more accurate.

For VOD (Video On Demand) systems, the RPAS server, shown in FIG. 7, runs at the head end and intercepts every RTSP request sent to the head end VOD server from a client. The RPAS's purpose is to inject commercials into the VOD ad stream based on the connecting client or subscriber's individual targeted advertising profile. When a client requests a VOD asset, RPAS uses the DMS provided profile information and associates the user's targeted advertising profile. The RPAS then checks for a targeted ad playlist that matches the individual user's profile. If a match is found, then the playlist which is composed of a series of commercials, is sent to the client followed by the VOD asset the user originally requested.

The RPAS communicates with the local DMS to obtain the profile information both for the client and the targeted ad profiles the VOD asset is targeted. In order to report on ad views, the RPAS updates the DMS database as advertising is streamed to the client.

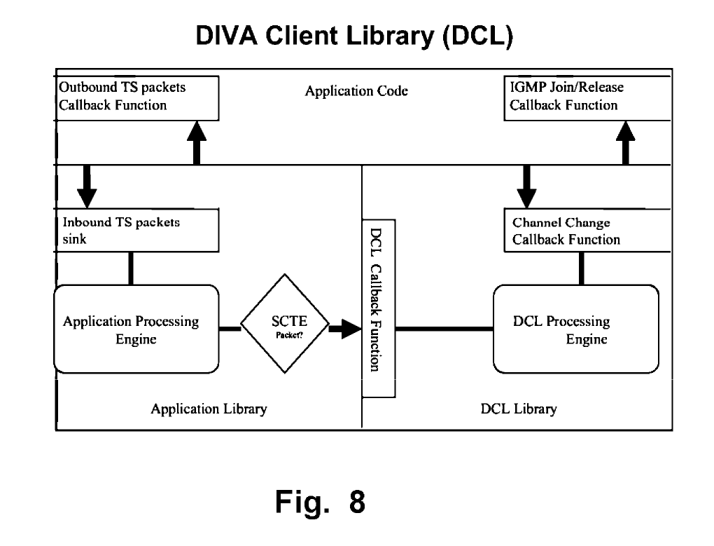

The DIVA Client Library (DCL) shown in FIG. 8, is adapted to run on the consumer client receiver device and is responsible for gathering consumer viewing habits and determining which advertising stream will be joined during commercial breaks. The DCL is a library that is loaded in the client device along with the content viewing application. When the DCL is initialized, it contacts the DMS to obtain its profile information. The DPG component provides the profile to the DMS which returns it to the DCL. The DCL then uses that profile to determine which commercial stream to switch to when an avail is detected.

The DCL then records all channel changes and viewing duration as well as the advertising contained within the linear stream. The viewing application passes each packet of data it receives to the DCL which inspects it for avails. As avails are detected, the DCL checks its profile against the profiles the avail is targeted at. If a match is made, the DCL switches to the ad stream indicated in the avail.

Periodically, the DCL will send channel and advertising viewing information to the DTS. The DTS then stores this information in the SQL database for both billing, analysis and profile generation functions.

While all of the fundamental characteristics and features of the method and apparatus have been shown and described herein, with reference to particular embodiments thereof, a latitude of modification, various changes and substitutions are intended in the foregoing disclosure and it will be apparent to those skilled in the art after reading this disclosure, that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A method for provision of advertising to viewers of broadcast media comprising the steps of:
identifying individual receivers of said broadcast media employing a receiver identifier that is specific to individual said receivers;
assembling a viewer database of individual viewers of said broadcast media;
employing software to achieve a matching of said individual viewers with one or a plurality of said individual receivers in said viewer database;
from available sources of individual viewer purchasing preferences, determining respective purchasing preferences of said respective individual viewers in said viewer database;
determining individual time periods during said broadcast media communicated to said individual receivers, where broadcaster advertisements are scheduled;
storing seller advertisements from sellers of products and services on a server;
employing said individual user preferences to ascertain which of said seller advertisements provides information concerning products or services of interest to respective said viewers; and
during said individual time periods, substituting said broadcaster advertisements sent to said receivers associated with said respective viewers, with said seller advertisements determined to be of interest to said respective individual viewers, whereby said viewers receive said seller advertisements associated as of interest to them, instead of said broadcast advertisements.

2. The method for provision of advertising to viewers of claim 1 including additionally:
placing receiver software adapted to track said viewers and to determine broadcast media preferences of each said viewer;
employing said receiver software to communicate electronically with a server hosting said viewer database;
communicating individual said viewers preferences for individual programs of said broadcast media to said server be added to said user profile; and
anticipating said individual said viewers future viewing times based on said preferences for individual programs and during said individual programs said seller advertisements determined of interest to said respective viewer for said broadcast advertisements.

3. The method for provision of advertising to viewers of claim 1 including additionally:
communicating to an electronic storage device on said individual receivers one or a plurality of said seller advertisements; and
employing software adapted to run on said individual receivers to ascertain said individual time periods of broadcast advertising and to display said stored seller advertisements during said time periods.

4. The method for provision of advertising to viewers of claim 2 including additionally:
communicating to an electronic storage device on said individual receivers one or a plurality of said seller advertisements; and
employing software adapted to run on said individual receivers to ascertain said individual time periods of broadcast advertising and to display said stored seller advertisements during said time periods.

5. The method for provision of advertising to viewers of claim 1 including additionally:
providing subscribing advertisers remote servers in different geographic areas, said remote servers in operative communication with local broadcast systems serving local said viewers;
allowing said advertisers to upload advertisements for products, and preferred said purchasing preferences of viewers for said products;
employing software running on said remote server to communicate with a said viewer database and ascertain specific said viewers having said preferred purchasing preferences; and
during said individual time periods, substituting said broadcaster advertisements on a said remote server with said advertising for products stored on said remote server to said specific said viewers identified as having said preferred purchasing preferences.

6. The method for provision of advertising to viewers of claim 2 including additionally:
providing subscribing advertisers remote servers in different geographic areas, said remote servers in operative communication with local broadcast systems serving local said viewers;
allowing said advertisers to upload advertisements for products, and preferred said purchasing preferences of viewers for said products;
employing software running on said remote server to communicate with a said viewer database and ascertain specific said viewers having said preferred purchasing preferences; and
during said individual time periods, substituting said broadcaster advertisements on a said remote server with said advertising for products stored on said remote server to said specific said viewers identified as having said preferred purchasing preferences.

7. The method for provision of advertising to viewers of claim 3 including additionally:
providing subscribing advertisers remote servers in different geographic areas, said remote servers in operative communication with local broadcast systems serving local said viewers;
allowing said advertisers to upload advertisements for products, and preferred said purchasing preferences of viewers for said products;
employing software running on said remote server to communicate with a said viewer database and ascertain specific said viewers having said preferred purchasing preferences; and
during said individual time periods, substituting said broadcaster advertisements on a said remote server with said advertising for products stored on said remote server to said specific said viewers identified as having said preferred purchasing preferences.

8. The method for provision of advertising to viewers of claim 4 including additionally:
providing subscribing advertisers remote servers in different geographic areas, said remote servers in operative communication with local broadcast systems serving local said viewers;
allowing said advertisers to upload advertisements for products, and preferred said purchasing preferences of viewers for said products;
employing software running on said remote server to communicate with a said viewer database and ascertain specific said viewers having said preferred purchasing preferences; and
during said individual time periods, substituting said broadcaster advertisements on a said remote server with said advertising for products stored on said remote server to said specific said viewers identified as having said preferred purchasing preferences.

9. The method for provision of advertising to viewers of claim 5 including additionally:
assigning respective said subscribing advertisers, specific geographic areas where specific types of said products uploaded to said remote server may be sold; and
ascertaining if a respective said advertiser is assigned the geographic area where said advertiser wishes to communicate their respective advertisements for products stored on said server.

10. The method for provision of advertising to viewers of claim 6 including additionally:
assigning respective said subscribing advertisers, specific geographic areas where specific types of said products uploaded to said remote server may be sold; and
ascertaining if a respective said advertiser is assigned the geographic area where said advertiser wishes to communicate their respective advertisements for products stored on said server.

11. The method for provision of advertising to viewers of claim 7 including additionally:
assigning respective said subscribing advertisers, specific geographic areas where specific types of said products uploaded to said remote server may be sold; and
ascertaining if a respective said advertiser is assigned the geographic area where said advertiser wishes to communicate their respective advertisements for products stored on said server.

12. The method for provision of advertising to viewers of claim 8 including additionally:
assigning respective said subscribing advertisers, specific geographic areas where specific types of said products uploaded to said remote server may be sold; and
ascertaining if a respective said advertiser is assigned the geographic area where said advertiser wishes to communicate their respective advertisements for products stored on said server.
